(19) United States
(12) Patent Application Publication
(10) Pub. No.: US 2002/0174425 A1
(43) Pub. Date: Nov. 21, 2002

(54) Collection of affinity data from television, video, or similar transmissions

(76) Inventors: Steven O. Markel, Highlands Ranch, CO (US); Ian Zenoni, Highlands Ranch, CO (US); Thomas Lemmons, Evergreen, CO (US)

Correspondence Address: The Law Offices of William W. Cochran, LLC, Suite 230, 3555 Stanford Road, Fort Collins, CO, 80525, US

(21) Appl. No.: 10/046,618

(22) Filed: Oct. 26, 2001

Related U.S. Application Data
(60) Provisional application No. 60/243,506, filed on Oct. 26, 2000.
(60) Provisional application No. 60/275,295, filed on Mar. 13, 2001.

(51) Int. Cl. H04N 7/16; H04H 9/00

(52) U.S. Cl. 725/13

(57) ABSTRACT

Disclosed is a system and method for generating affinity data, i.e. data that indicates the interest of a viewer or user in broadcast information such as a video, audio or data broadcast. Automated or manual selection can be made either at an upstream site or at the set-top box for selecting alternative sources of content based upon the affinity data. Return channels can be provided through upstream transmissions through a cable, Internet connections, etc. to an origination site which may comprise a content provider, a TV studio, a head-end, or other upstream location. Affinity data can be remotely sensed by sensors, that are built in or connected, to the set-top box. Further, affinity data can be manually generated by the viewer or user, by various methods such as manually entering data in response to trigger icons that appear on a video broadcast or audio transmission. Triggers for triggering responses and transmitting data can be inserted in the vertical blanking interval of a video feed or can be periodically generated by the set-top box.

### CROSS REFERENCE TO RELATED APPLICATIONS

The present application claims priority to U.S. provisional application No. 60/243,506 entitled “Collection of Affinity Data from Television, Video, or Similar Transmissions” by Steven O. Markel, Thomas Lemmons, and Ian Zenoni filed Oct. 26, 2000, and U.S. provisional application No. 60/275,295 entitled “Affinity Marketing for Interactive Television” by Steven Markel filed Mar. 3, 2001, the entire content of both applications is hereby incorporated by reference for all they teach and disclose.

### BACKGROUND OF THE INVENTION

a. Field of the Invention

The present invention pertains generally to interactive television and video systems and more particularly to the collection, analysis, and transmission of affinity data.

b. Description of the Background

To date, it has been difficult to collect data regarding the interest in television content, video content, and the content of data that may be broadcast to a user. For example, sample data approaches that are used by rating companies such as Neilson are used to provide rating information (affinity data) that indicates the affinity or interest that a watcher/user may have to the information such as the video, audio, or data that is being watched or used by the user. Advertisers, programmers, content providers, analysts, etc. have a need for reliable rating information that can be provided on either a real-time or near real-time basis. Currently, feedback is primarily provided with long lead times using sample data or focus groups that may be unreliable or delayed sufficiently to diminish the value of such data.

The collected data may also have a low reliability because of the manner of collection of the data. For example, companies like Neilson may use manual data collection techniques which require manual logging of activity and ratings. Manual recording of affinity data leads to many inaccuracies and inefficiencies. For example, one potential inaccuracy can occur when the TV is on during a meal. The viewer may have logged the show that is being watched, but is clearly occupied with other pursuits. Similarly, some viewers may tune to stations that play music videos and use these stations for background music. These viewers only occasionally glance at the TV. Other inaccuracies occur when viewers change channels during advertisements. In this instance, the program is actually being watched, but the advertisement is not watched. Although the data points indicate that a high number of viewers are watching a particular program and advertisers base their sponsorship on these numbers, the advertisers are not obtaining an accurate report as to whether their commercials are actually being viewed. Further, this type of sampling of data does not provide any indication as to whether the viewer is reacting favorably or not to the content of the data that is being broadcast. For example, a viewer may turn away, turn the sound down, or change channels during one segment of a show, and then return to that show when the content becomes more compelling. For example, consider a viewer watching a baseball game who is only interested in watching a particular player. The viewer may tune away knowing that the player will not be at bat for several innings. The viewer may log that game as being watched for its entire duration, yet only pay attention to certain small portions of the game.

Hence, current methods of sampled data do not accurately reflect viewer selections or the viewer's response to any particular video segment such as a commercial, a joke or series of jokes, a political debate, or any particular video clip.

Inefficiencies also occur in the reporting method. The time delay associated with reporting the viewing data is a prominent problem. The recordation and later forwarding of the data under current techniques of collection result in inherently long lead times in providing analyzed data. For example, the use of a log book to log entries as to the particular programs that have been watched requires the collection of the log books and analysis of that data. This is a lengthy process. Although some automated methods have been developed for determining to which channels a TV has been tuned, such methods are many times inaccurate because of the fact that the TV may be left tuned to a particular station when the viewer actually leaves the home or apartment. Further, these techniques do not provide affinity (interest) data.

Current reporting methods are also unable or inaccurate in collecting “call to action” data. For example, many advertisements attempt to persuade a viewer to make a telephone call, connect to the Internet to purchase an item, or travel to a store to purchase an item. Most of these advertisements include deadlines such as setting a time period to respond in order to obtain a discount. Currently, the methods of collecting data to determine if these “call to action” type of commercials are successful are either inaccurate or do not exist.

It would therefore be advantageous to provide a system in which viewer activity as well as viewer affinity to content can be determined. Such data, collectively referred to as affinity data, can be extremely valuable to advertisers, content providers, political organizations, analysts, and other such organizations, especially if that data can be provided on a real-time or near real-time basis. Further, it would be advantageous to utilize affinity data to direct the programming of alternative video segments from an origination site such as a TV producer, a head-end, etc. or locally on the set-top box.

### SUMMARY OF THE INVENTION

The present invention overcomes disadvantages and limitations of the prior art by providing a system in which affinity data is collected and can be made available for use on either a real-time or near real-time basis. The present invention utilizes feedback systems from the viewer that provide raw data to the set-top box that can be analyzed to generate affinity data. The raw data can comprise biometric data such as biological responses of the viewer, manually entered data, such as data that is manually entered through a remote control device, motion sensors, audio sensors, or any other types of sensors or devices for providing direct feedback from the viewer in response to the programming content that is being provided in the broadcast. Sensing of information could be done either actively by having devices connected directly to the viewer, or passively by simply detecting information from the set-top box. The system can be used with video broadcast information such as TV shows, movies, sporting events, etc., audio broadcasts through a cable or other downlink, or with data such as video games, software programs, etc.

The present invention may therefore comprise a method of selecting and displaying a video segment to a viewer comprising: transmitting a plurality of video segments from a broadcast center to a viewer; displaying the video segments to the viewer; sensing input from the viewer through at least one sensor; transmitting the input to a remote computer; analyzing the input to generate affinity data; selecting a specific video segment based on the affinity data; transmitting the specific video segment from the broadcast center to the viewer; and displaying the specific video segment to the viewer.

The present invention may further comprise a method of collecting affinity data comprising: transmitting a plurality of video segments from a broadcast center to a viewer; displaying the video segments to a viewer; sensing input from the viewer through at least one sensor; analyzing the input to generate affinity data; selecting a specific video signal from a plurality of video signals being broadcast to the viewer, the selection being based on the affinity data; transmitting the affinity data to a remote computer; and displaying the specific video signal to the viewer.

The advantageous of the present invention are that affinity data can be collected on a real-time or nearly real-time basis that provides valuable information to affinity data users such as content providers, networks, advertising agencies, software vendors, producers, etc. Because of the real-time or nearly real-time format of this data, various decisions can be made quickly by the affinity data users for various purposes such as changing the content of the programming, branching to alternative segments, providing different viewing angles of the content, altering approaches during political debates, removing advertising more quickly that is offensive or unsuccessful for other reasons, designing future advertising campaigns based upon successful results, etc. Further, real time analysis of the affinity data may be used for real time contact of the viewer through telemarketing, Internet marketing, or other direct marketing techniques. Analysis of the data in real-time or nearly real-time allows for immediate decisions to be made to alter the program content and provide affinity data users with valuable affinity data. Of course, various methods can be used for analyzing the raw data that is obtained from the sensors to determine the affinity rating. Further, techniques can be used to obtain the desired data in a reliable manner. For example, various triggering techniques can be utilized to obtain data at predetermined sampling times. A trigger may be placed in a video feed during the video blanking interval (VBI) to prompt a response from the viewer. A prompt may occur during a commercial such that the user can enter a response. Further, rewards may be provided for users that provide responses such as discounts on products or reduction in cable billing rates, etc.

These advantages of the invention will become more apparent from the preferred embodiment of the invention and the appended claims.

### BRIEF DESCRIPTION OF THE DRAWINGS

In the drawings,

FIG. 1 is a schematic block diagram that generally illustrates one embodiment of the present invention.

FIG. 2 is a schematic block diagram that generally illustrates another embodiment of the present invention.

FIG. 3 is a schematic block diagram that generally illustrates a further embodiment of the present invention.

FIG. 4 is a schematic block diagram that illustrates a further embodiment of the present invention.

FIG. 5 is a schematic block diagram illustrating a further embodiment of the present invention.

FIG. 6 is a schematic block diagram illustrating a further embodiment of the present invention.

FIG. 7 is a schematic block diagram illustrating one embodiment of the set-top box.

FIG. 8 is a schematic block diagram illustrating an implementation of the set-top box with discrete sensors.

FIG. 9 is a schematic flow diagram of the functions performed by the set-top box in capturing, storing, and later transmitting data.

FIG. 10 is a schematic flow diagram of the functions of the set-top box in capturing, storing, and transmitting data in real-time or nearly real-time.

### DETAILED DESCRIPTION OF THE INVENTION

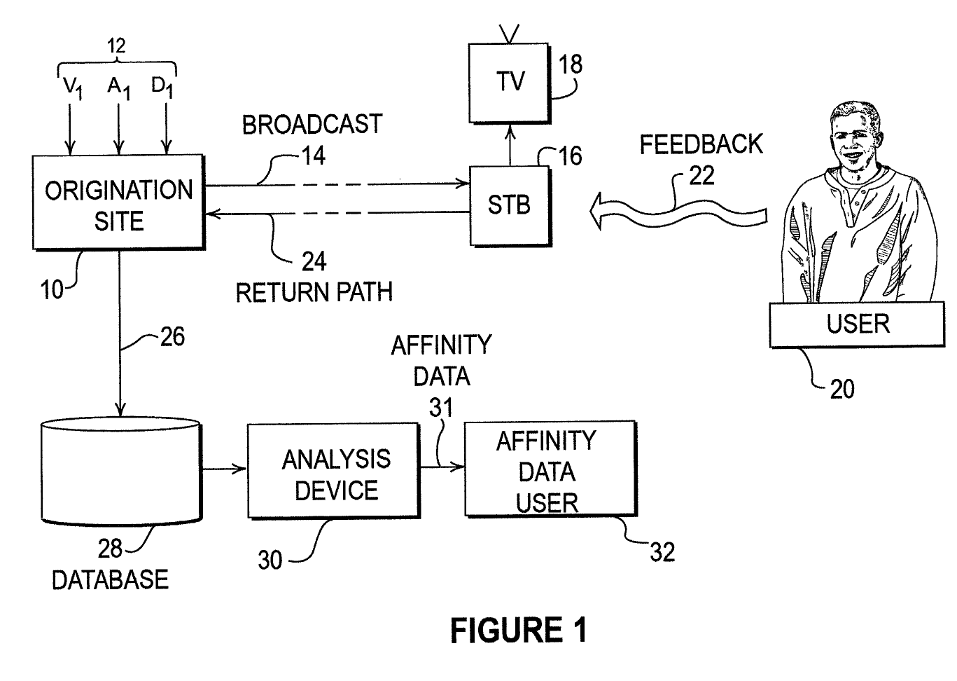

FIG. 1 is a schematic block diagram that generally illustrates one embodiment to the present invention. As illustrated in FIG. 1, an origination site 10 either generates or provides video, audio, and/or data information 12. For example, an origination site may be a content provider such as a TV network, a TV studio, a live broadcast from a sporting event such as a football game, a server providing data such as an applications service provider, an Internet service provider, and any other type of content provider that may be capable of broadcasting content to users through cable connections, satellite connections, RF connections, etc. The embodiment of FIG. 1 shows only a single source of content 12, whereas other embodiments illustrated herein provide multiple sources of content. The origination site can also comprise a head-end device that is connected to one of the content providers that supplies the source of content.

As also shown in FIG. 1, the content that may comprise video (V₁), audio (A₁), and/or data (D₁), which are collectively referred to as the content data 12, are broadcast over a link 14 to a set-top box 16. The link may comprise of a RF link, satellite link, a cable connection, etc. The set-top box 16 is connected to a TV 18 which may comprise a monitor or type of display device for displaying information provided by the set-top box 16. Of course, the set-top box 16 can be incorporated in the TV 18 or any other type of display and constitute an integral portion of the display if desired. The set-top box 16 is capable of obtaining feedback information 22 that is provided by a user 20. As explained in more detail herein, the feedback information 22 can comprise various types of information such as biometric data, manual data, audio data, visual data, recognition data, etc. In addition, this data can be collected in many different ways such as by remotely sensing information pertaining to the viewers, by connection directly to the viewer, or detecting manually entered data provided by the viewer, as well as other techniques disclosed herein.

Referring again to FIG. 1, the feedback data 22 that is obtained by the set-top box 16 in some manner is transmitted back to the origination site 10 by a return path 24 which can comprise any one of the return paths disclosed herein. For example, the return path can be out of band transmissions in the upstream path through a cable, a RF connection, a satellite link, etc. Further, the return path 24 can be an asymmetric link such as a telecommunications link or any other desired uplink. Further, the data provided on the return path 24 can either be analyzed at the set-top box 16, or can comprise the raw feedback data 22 that is obtained by the set-top box 16. As illustrated in FIG. 1, the feedback data is not analyzed in the set-top box 16 but may be processed in some fashion prior to transmission on the return path 24 to the origination site 10. The origination site 10 then transmits the feedback data to a database 28 via link 26. The database 28 may be located at the origination site or at a remote location. The database 28 stores the data such that the analysis device 30 can access the feedback data that has been stored in database 28. The analysis device can comprise an analysis computer or any other type of device that is capable of analyzing the feedback data 22 to generate affinity data 31. The affinity data 31 is then transmitted to an affinity data user 32 that can use this data for various purposes as disclosed herein, such as statistical analysis, content selection, immediate marketing, etc.

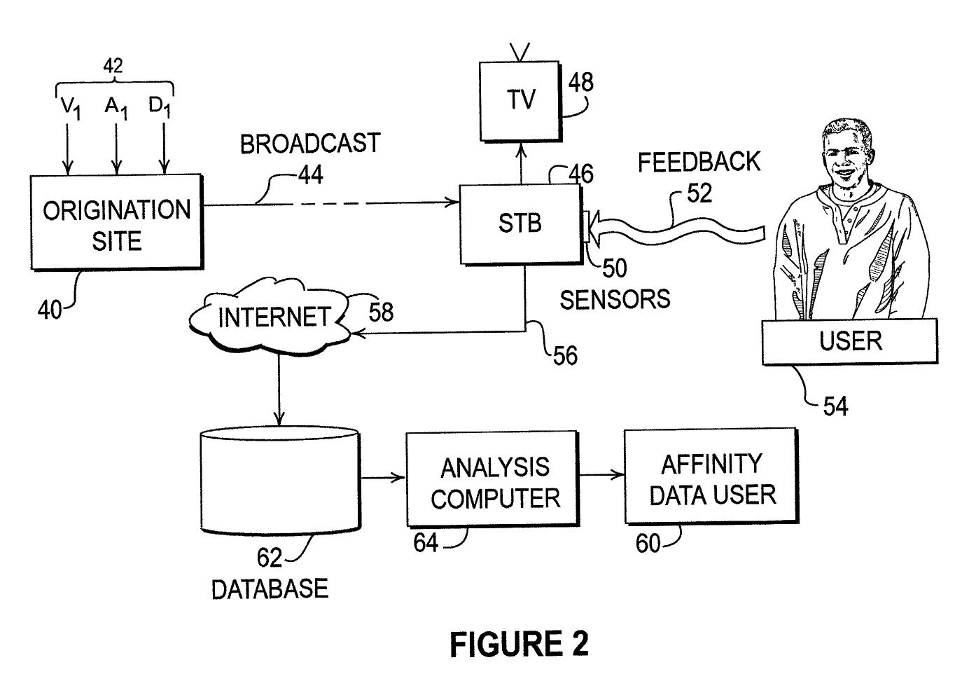

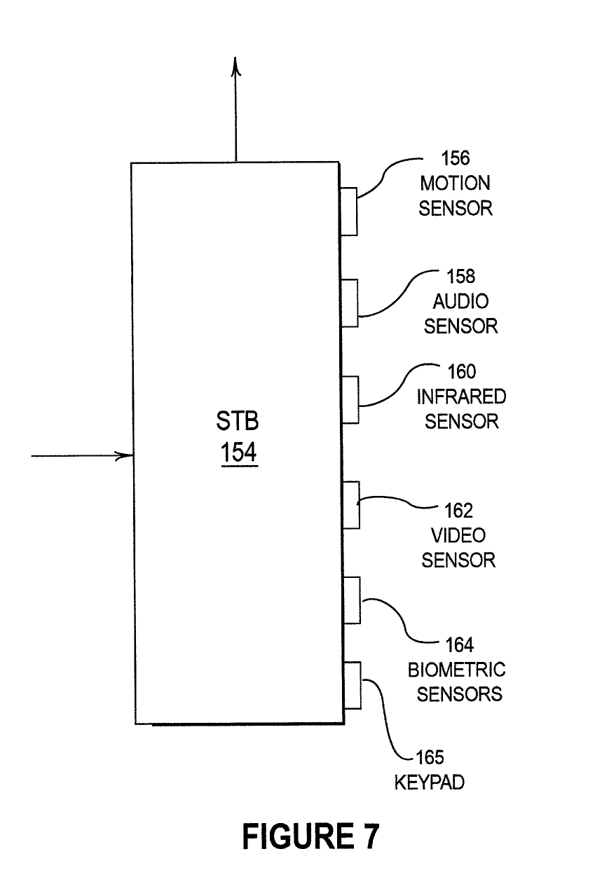

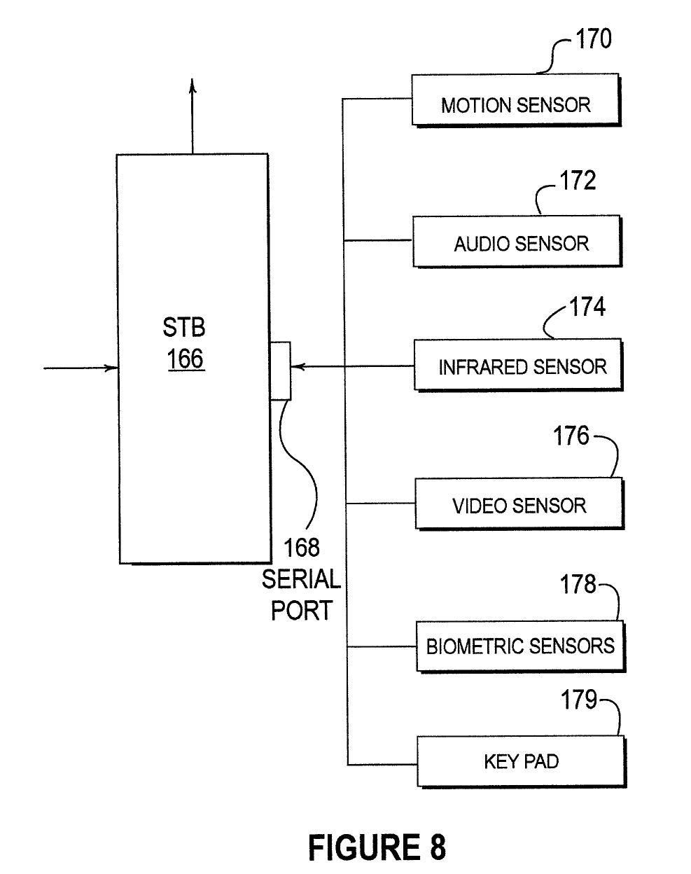

FIG. 2 is a schematic block diagram that generally discloses another embodiment of the present invention. As shown in FIG. 2, an origination site 40 may internally generate or receive from outside sources video (V₁), audio (A₁), and/or data (D₁), collectively referred to as content 42. The content 42 is broadcast on a link 44, which again may constitute any desired link to a set-top box 46. Set-top box 46 provides the broadcast content to a TV 48, which again may comprise any type of display such as plasma displays, flat panel displays, CRT monitors, etc. The set-top box 46 is equipped with one or more sensors 50 that are capable of sensing the feedback data 52 from the user 54. The sensors may be built into the set-top box, such as illustrated in FIG. 7, or may constitute one or more individual sensors that are connected to the set-top box via a serial port, as illustrated in FIG. 8.

Returning to FIG. 2, the feedback information 52 is sensed by one or more sensors 50. The set-top box 46 may provide some processing of the feedback data prior to transmission on link 56 through the Internet 58. For example, the set-top box may wrap the feedback data 52 in an IP transport and address the data for transmission through the Internet 58 to the IP address of the affinity data user 60. Of course, with the advent of interactive TV, set-top box 46 is capable of generating IP signals that can be transmitted to any desired IP address over the Internet.

As shown in FIG. 2, once the feedback data 52 is processed and packaged for transmission on the Internet 58, it is sent to an affinity database 62 and an analysis computer 64. The database 62 stores the feedback data that is received from the Internet connection and provides that data to an analysis computer 64. The analysis computer 64 analyzes the feedback data to generate affinity data that can be used by the affinity data user 60.

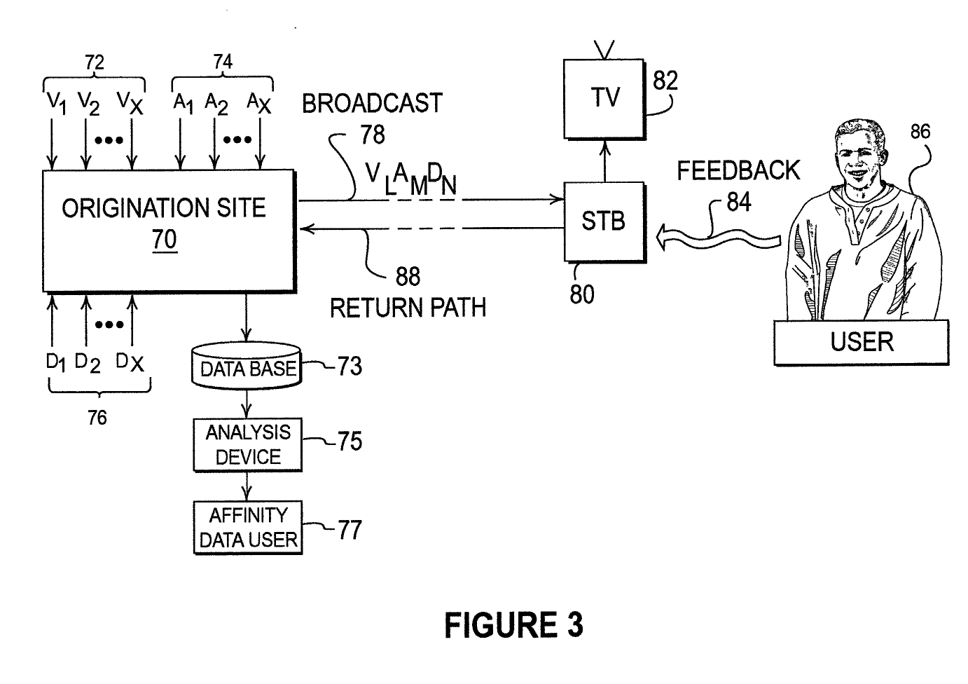

FIG. 3 is a schematic block diagram of another embodiment of the present invention that may either internally generate or receive multiple sets of content information. As shown in FIG. 3, an origination site 70 such as a TV studio, a head-end, etc. may receive multiple video feeds 72, multiple audio feeds 74, and/or multiple data feeds 76. In response to the feedback data provided on return path 88, the origination site 70 selects a particular set of content for broadcast on the link 78. For example, a particular video feed (V_{L}), a particular audio feed (A_{M}), and/or a particular set of data (D_{N}) may be provided by the origination site 70 in response to the feedback data provided on the return path 88.

As shown in FIG. 3, the content data V_{L}, A_{M}, and/or D_{N} is broadcast to the set-top box 80 via link 78. The set-top box 80 then transmits the content to TV 82 which may comprise any desired type of display or a computer in the case where data is being supplied such as software for use on a computer. For example, the origination site 70 may comprise an ASP, and the TV 82 may comprise a computer that is utilizing software provided by the ASP 70.

As shown in FIG. 3, the user 86 provides feedback data 84 in any one of the ways disclosed herein to the set-top box 80. The feedback data is then provided via the return path to the origination site 70. Again, the return path can comprise any one of the desired return paths disclosed herein. FIG. 3 therefore provides feedback data to the origination site 70. The origination site 70 can then process the feedback data to generate affinity data using an analysis computer to select a particular set of content data 72, 74, 76 for broadcast over link 78. The origination site 70 may use any desired techniques for providing alternative sources of content information based on the affinity data that is generated from the feedback information 84 obtained by the set-top box 80.

As shown in FIG. 3, the origination site 70 may transmit affinity data to a database 73. The affinity data in the database 73 may be analyzed by an analysis device 75 and prepared for an affinity data user 77.

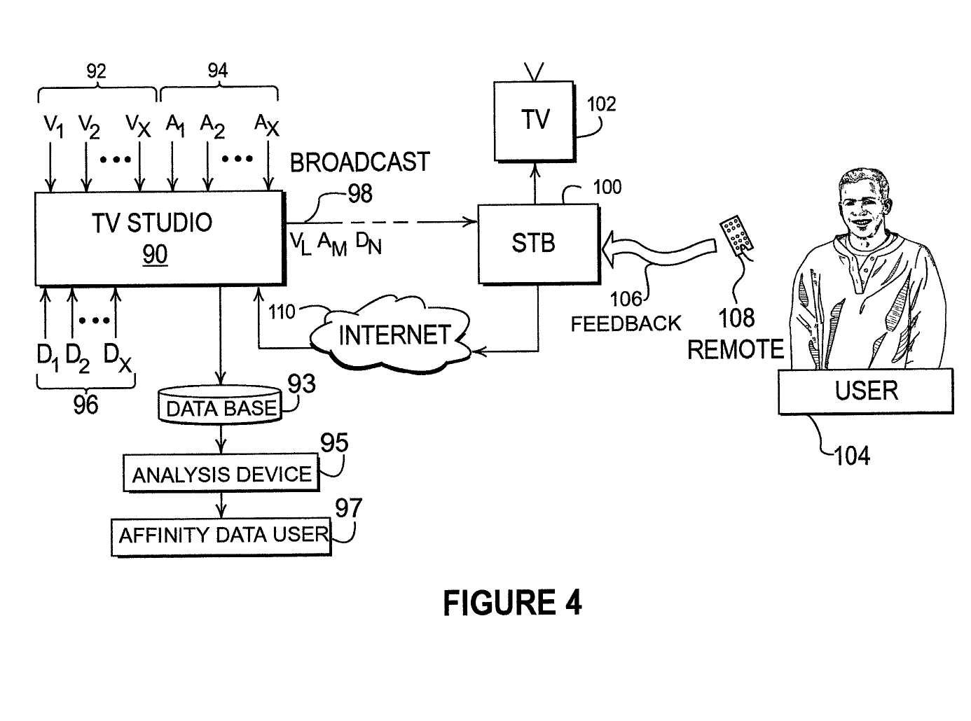

FIG. 4 is a schematic block diagram that illustrates another implementation of the present invention. As shown in FIG. 4, a TV studio 90 receives various feeds of content information such as video feeds 92, audio feeds 94, and data feeds 96. The TV studio 90 can comprise a TV studio receiving live feeds of content information such as a trailer located outside of a football stadium that is receiving live video and audio feeds relating to the football game. The TV studio may have multiple monitors for displaying the multiple video feeds as well as multiple audio feeds. The TV producer may then select particular content for video broadcast on link 98. For example, the TV producer may decide at any particular time to transmit a particular video feed V_{L}, a particular audio feed A_{M}, and a particular data feed D_{N}. The data feed, for example, may constitute closed captioning data. In addition, it may provide data such as statistics regarding players and other factual information. As shown in FIG. 4, the broadcast of the content data is provided over link 98 to the set-top box 100. Again, the link 98 can comprise any desired link such as disclosed herein. The set-top box 100 provides the content to TV 102 for display. Again, the TV 102 can comprise any of the desired devices such as a separate computer with a monitor, a flat panel display, a cathode ray tube display, etc. Set-top box 100 is arranged to receive feedback data 106 from a remote control device 108 that is operated by the user 104. The feedback data is then provided by the set-top box 100 over the Internet connection 110 to the TV studio 90.

As shown in FIG. 4, the TV studio 90 may transmit affinity data to a database 93. The affinity data in the database 93 may be analyzed by an analysis device 95 and prepared for an affinity data user 97.

In operation, the user 104 of FIG. 4 may generate feedback data 106 using remote control 108 when prompted by triggers provided in the broadcast transmission 98. The TV producer in the TV studio 90 may periodically alter the content feed and provide triggers to prompt responses from the user 104 to generate feedback data from the remote control 108. For example, during a football broadcast the producer may provide end zone shots during certain plays and generate a trigger to prompt a response of feedback data from the user 104. Depending upon the responses provided, various angles can be displayed to the user. Further, various audio feeds can be provided. For important live events, various levels of content information can be provided on different channels. For example, during a Super Bowl broadcast one channel may provide the standard video and audio content that is of interest to standard viewers. The audio content may contain information of interest to standard viewers such as “the momentum of the game” and other types of novice information. Similarly, the video may track the motion of the quarterback and provide shots of the ball flying through the air prior to reception. A more advanced version of the game may not isolate on individual players during the live feed but may show video such as game clips that provide a view that includes both the offense and defense. The audio clips may be more advanced and refer to the particular offensive and defensive sets and the particular plays that are run from these sets by both the offense and defense. An even more advanced set of information can be provided on alternate audio and video feeds as well as alternative data feeds. Again, these are just examples of a particular use of the content data. Of course, the feedback data 106 can provide the TV producer with an indication of the sophistication of the user 104 so that the broadcast 98 can be designed to meet that particular sophistication level. Although the feedback is shown as being provided through the Internet 110 in accordance with FIG. 4, it can be provided in any desired manner to the producer in the TV studio, such as the other methods disclosed herein. Further, manual inputs can be provided by any desired method as an alternative to the remote control device 108.

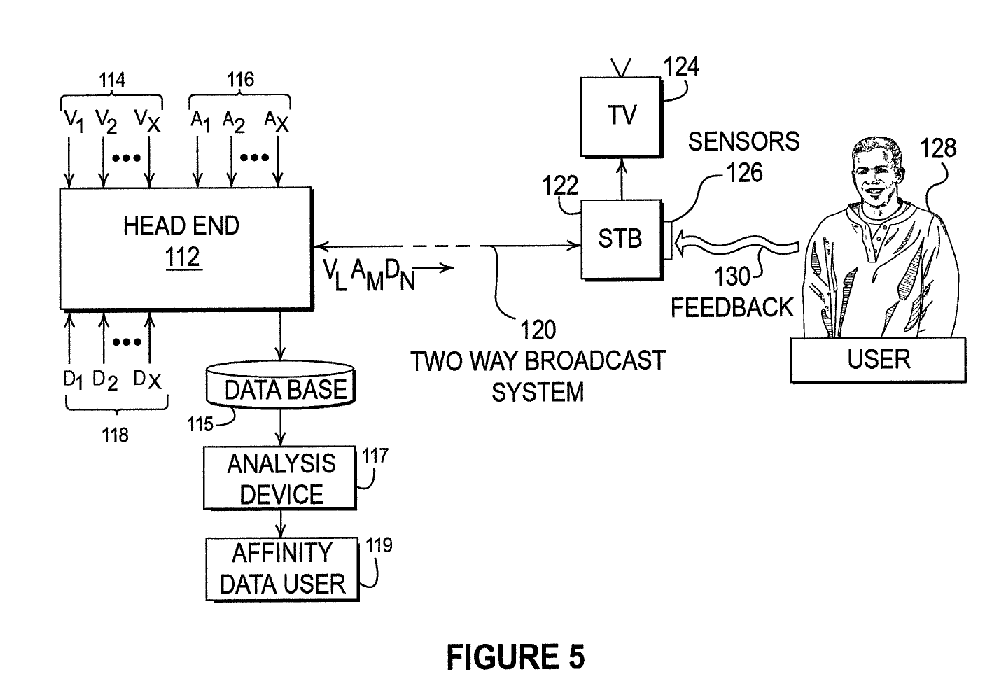

FIG. 5 is a schematic block diagram of another embodiment for the present invention. As shown in FIG. 5, a head-end 112 receives multiple video feeds 114, multiple audio feeds 116, and/or multiple data feeds 118. Head-end 112 selects a certain video, audio, and/or data feeds (V_{L}, A_{M}, D_{N}) based upon feedback information provided over the two-way broadcast system 120. The two-way broadcast system 120 may comprise a cable system 120 in which the video, audio, and/or data feeds are provided downstream to the set-top box 122 while feedback information 130 is provided upstream via the cable 120 to the head-end 112. The upstream communication over the cable 120 to the head-end 112 can be out-of-band signaling such as digital data streams that co-exist on the cable with the regular broadcast data that is being transmitted downstream. The set-top box 122 transmits the content information to the TV 124, which again, can constitute any desired type of device such as a computer or a display device. The set-top box 122 contains one or more sensors 126 that sense the feedback information 130 that is generated by the user 128. The head-end 112 may contain analysis computers that analyze the feedback data 130 and automatically select the content feed that is transmitted downstream to the set-top box 122. The analysis computer (not shown) that is contained within the head-end 112 generates affinity data that provides automatic selection criteria to select the particular type of content that is desired by the majority of the user 128 that provide feedback data 130. Alternatively, the ID codes of each of the set-top boxes 122 can be provided with the upstream data that identifies the particular set-top box and the associated affinity data. In other words, the feedback data 130 that is provided upstream to the head-end 112 can also contain an associated ID for the set-top box 122. The head-end 112 can then process the feedback data 130 to generate affinity data to automatically select the content feed 114, 116, 118 to which the user 128 shows an affinity. A video stream can then be placed on the downstream portion of the two-way broadcast system 120 with a decoding signal for the set-top box 122 in the same fashion as the decoding signals are provided to set-top boxes for Pay-for-View broadcasts. The set-top box 122 may be required to be changed to a different channel to receive the preferential broadcast that is custom selected by the head-end 112 from the various content data based upon the viewer preferences are sensed by the feedback data 130. A control signal from the head-end 112 can be generated to tune the set-top box 122 to the specific channel based on those preferences.

In other words, automated selected based upon feedback data that may be provided automatically through the use of sensors on the set-top box, or otherwise, can be provided by the system illustrated in FIG. 5. Additionally, automatic tuning of the set-top box can be used to automatically provide the customized content to the user 128.

As shown in FIG. 5, the head end 112 may transmit affinity data to a database 115. The affinity data in the database 115 may be analyzed by an analysis device 117 and prepared for an affinity data user 119.

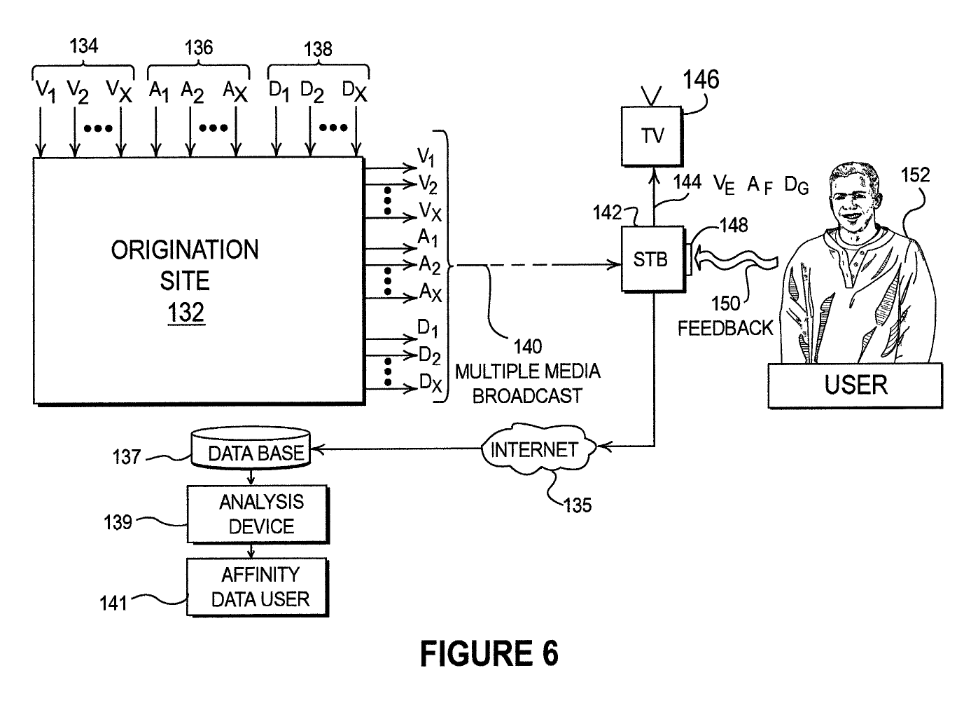

FIG. 6 is a schematic block diagram illustrating another implementation of the present invention. As shown in FIG. 6, an origination site 132 obtains from an outside source, or internally generates, multiple video feeds 134, multiple audio feeds 136, and/or multiple data feeds 138. The origination site 132, which can comprise any of the different types of origination sites disclosed herein, produces a multiple media broadcast 140 that contains all or a subset of the content data 134, 136, and/or 138. This multiple media broadcast 140 is transmitted over a link to the set-top box 142. The set-top box 142 contains one or more internally or externally mounted sensors for obtaining feedback data 150 from user 152. Set-top box 142 includes one or more logic devices, such as a microprocessor or state machine, that is capable of reading and processing the feedback data 150 to generate affinity data that can then be used to automatically select the combination of content data 134, 136, and 138 to which the user 152 shows affinity. As also shown in FIG. 6, the selected video (V_{E}, A_{F}, D_{G}) 144 is then transmitted to the TV 146 for display. Again, the TV can comprise any desired type of display device or a computer. The sensing of feedback data 150 can occur in any of the desired ways described herein such as via a remote control and biometric data provided by remote sensors or sensors that are actually connected to the user, for example. A typical way that the selection process may be performed locally at the set-top box, such as illustrated in FIG. 6, is that the various video feeds V₁ through Vₓ are provided by the set-top box 142 to the TV 146 and the user 152 says, “no” or “yes” to a particular video feed. An audio sensor having pattern recognition can recognize the “yes” or “no” response from the user. Further, the sensor may be able to detect other terms such as “change video” or “change audio” to allow other selections using the “yes” or “no” command. This is only one implementation of the embodiment illustrated in FIG. 6, and many other implementations can be provided for sensing and providing data for selection of the various content desired by the user 152. Of course, other forms of detection can be used for automatically selecting the desired content. Similarly, the user can simply indicate a desired selection on the remote control device by manually inserting a “yes” or “no” answer to a particular content stream. For example, a series of video clips, audio clips, or different data can be provided, and the sensors can detect data and analyze that data to generate affinity data for selecting the preferred content.

As shown in FIG. 6, the set top box 148 may transmit affinity data via the Internet 135 to a database 137. The affinity data in the database 137 may be analyzed by an analysis device 139 and prepared for an affinity data user 141.

FIG. 7 is a schematic illustration of a set-top box 154 having a plurality of built it or attached sensors. As shown in FIG. 7, the set-top box 154 can include a motion sensor 156, an audio sensor 158, an infrared sensor 160, and video sensor 162, various biometric sensors 164, and a keypad 165. Motion sensor 156 can be used to detect motion within the room where people are viewing the broadcast. The amount of motion in the room can indicate the level of interest or affinity to a particular program that is showing. For example, if this motion sensor senses a great deal of motion in the room, which may provide an indication that there is very little interest in the display broadcast. Further, if there is no motion in the room whatsoever that may indicate that there is either no one in the room or that anyone who is in the room has fallen asleep. The motion sensor data can be analyzed in any desired fashion to generate the affinity data including empirical techniques. Of course, various methods of analyzing the motion data can be used with other sources of data to produce accurate affinity data.

The audio sensor 158 can be used to detect sources of noise within the room that may also aid in generating affinity data. For example, if the noise level is high within the room that may indicate that there is little attention being paid to the broadcast program. Additionally, the audio level of the program can be determined as well as the various frequencies at which that audio signal is being broadcast so that a feedback signal can be generated to cancel out the audio signal from the TV broadcast. Also, audio recognition techniques can be used to recognize the input of affinity data such as the user speaking the terms “poor,” “ok,” “good,” or “excellent.” In other embodiments, the user may clap once to indicate “good” and clap twice to indicate “bad”. Again, audio user data can be combined with other sensor data using various statistical methods to generate a reliable source of affinity data.

Infrared sensor 160 illustrated in FIG. 7 detects various types of infrared radiation. For example, infrared detector 160 may detect black body radiation to determine if and how many people are located in the room in which the broadcast is being displayed. In addition, the infrared sensor 160 are potentially capable of detecting changes in heart rate and other biometric factors of the individuals who are located in the room.

Video sensor 162 illustrated in FIG. 7 is capable of sensing video images of people within the room and may be designed to use recognition techniques for determining if the video image includes the images of people as opposed to animals, etc. In this fashion, the set-top box 154 can determine the number of people in the room that can be used in generating the affinity data.

FIG. 7 also indicates the use of biometric sensors 164. The biometric sensors 164 may be sensors that can be mounted in the set-top box 154 that detect biometric data of the people within the room to aid in generating affinity data. For example, various types of heart rate or pulse rate sensors may be able to remotely detect heart rate and pulse rate of individuals within the room and other types of biometric data that can be remotely sensed from the set-top box 154. Of course, any type of detector can be used to detect activity, motion, biometric responses, etc. of the individuals in the room to produce accurate affinity data indicating the interest of the viewer in the program that is being viewed.

Keypad 165 illustrated in FIG. 7 may be any form of key switch capable of being operated by a person. The keypad 165 may take the form of a standard computer keyboard, a button or set of buttons on a remote control, or any other type or configuration of key switches.

FIG. 8 is a schematic block diagram of another implementation of a set-top box 166. The set-top box 166 includes a serial port 168 that can be attached to a plurality of sensors. For example, serial data can be generated from the various sensors illustrated in FIG. 8 and transmitted to the serial port 168 of the set-top box 166. As shown in FIG. 8, the various sensors can include a motion sensor 170, an audio sensor 172, an infrared sensor 174, a video sensor 176, one or more biometric sensors 178, and keypad 179. Each of these three sensors can be configured as remote sensors. In addition, the biometric sensors 178 may be physically attached to various viewers to obtain biometric response data. For example, a galvanic skin resistance meter can be used to detect changes in galvanic skin resistance. Further, an electroencephalogram can be used to detect alpha or beta type waves that are generated by one or more viewers.

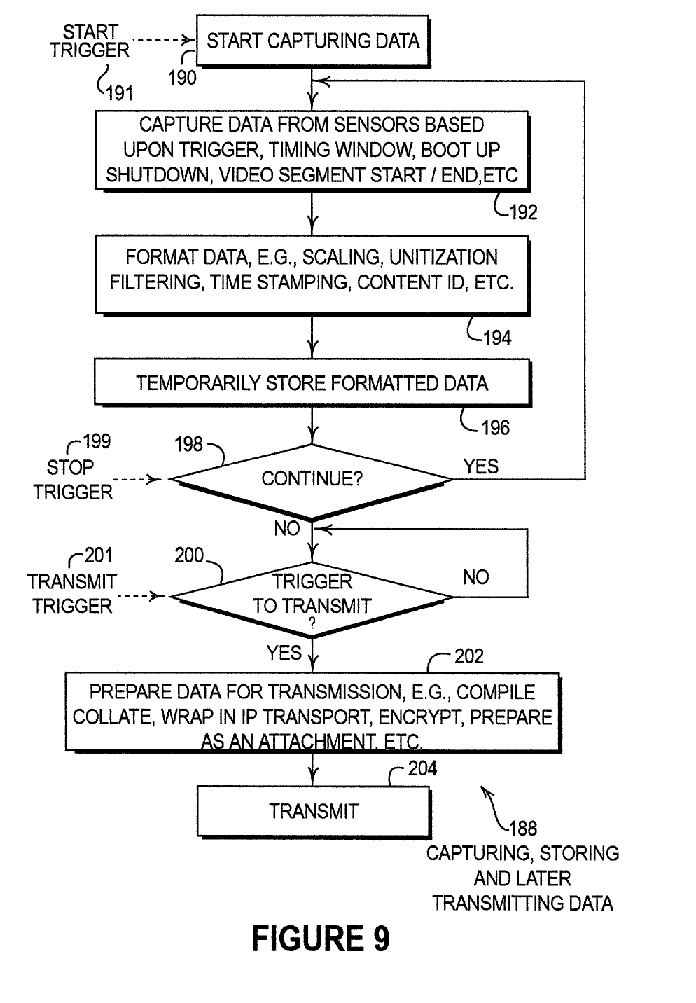

FIG. 9 is a flow diagram illustrating the steps 188 of capturing, storing, and later transmitting sensor data. At step 190, the set-top box begins the process of capturing sensor data from the sensors illustrated in FIGS. 7 and 8. The capturing of sensor data can be done periodically or in response to a start trigger 191. The start trigger 191 may be a signal that is generated by the content provider, head-end, studio producer, or other upstream source. The start trigger may be generated in the form of a tag or marker that is transmitted during the vertical blanking interval (VBI) in a manner similar to that disclosed in U.S. patent application Ser. No. 60/227,890 filed Aug. 25, 2000 entitled iSelect Video. At step 192, the data from the sensors is captured based upon the trigger, timing window, boot up of the system, shut down, or the beginning or end of a video segment, etc. Various periodic timing windows may be provided for detecting sensor data in a manner similar to a trigger signal. Further, sensor data may be sampled during a boot up of the system or shut down of the system. Additionally, markers and tags may be provided at the beginning/end of each video segment to gauge the response of a particular video segment. Tags, of course, may be generated at any time during a video segment such as after a joke has been told by a standup comedian, after a point has been made by a politician in a debate, during a commercial to gauge the interest in the commercial, and at other opportune times for sampling data. Again, these triggers can be inserted by TV producers during live broadcasts or can be preprogrammed into the video feed by content providers. Additionally, triggers can be inserted at the beginning and end of each video segment so that data can be captured for that data segment whether it is a scene in a movie, a commercial, a video skit, a music video, etc. Further, the triggers inserted in the VBI or triggers that are generated automatically within the set-top box as a result of a timing window or other triggering mechanisms can produce an icon on the video display indicating that the user should enter manual data during the timing window that the icon is displayed. The triggers may be broadcast to all set top boxes simultaneously or may be sent to individual set top boxes. The manual data may be entered via the remote control to indicate the level of interest of the viewer in the particular video segment. The viewer may be rewarded for manually responding to the display of the icon such as by entering the viewer into a grand prize drawing for each time the viewer enters data, providing rebate coupons for the purchase of items, or even reducing the cable TV bill by a certain amount each time the viewer responds. In this fashion, the viewer response by manually entering affinity data, or entering voice responses, is obtained.

As shown in step 194 of FIG. 9, the data that is collected from the sensors, including manual data entered by a viewer, is formatted. For example, it is scaled, unitized, filtered, time stamped and provided with a content ID number. Other types of formatting of the signal can also occur. At step 196, the formatted data is temporarily stored. At step 198, a decision is made as to whether to continue. For example, it may be determined whether a stop trigger 199 has been received during the vertical blanking interval. If a stop trigger has not been received, the process will continue to gather data and return to step 192. If a stop trigger has been received, the process will proceed to step 200 where a decision is made to transmit the data. For example, the set-top box may only transmit the data upon receiving a transmit trigger 201 in the vertical blanking interval. If a trigger has not been received to transmit, the process will loop on itself until a transmit trigger has been received. Further, the set-top box may be programmed to generate its own trigger signals that may occur during start up, shut down, or on some periodic basis. If a trigger has been received to transmit the data at step 200, the process proceeds to step 202 where the set-top box prepares the data for transmission. For example, the data may be compiled, collated, wrapped in an IP transport, encrypted, prepared as an attachment to an e-mail, or other type of preparation. At step 204, the data is then transmitted in accordance with one of the methods illustrated herein.

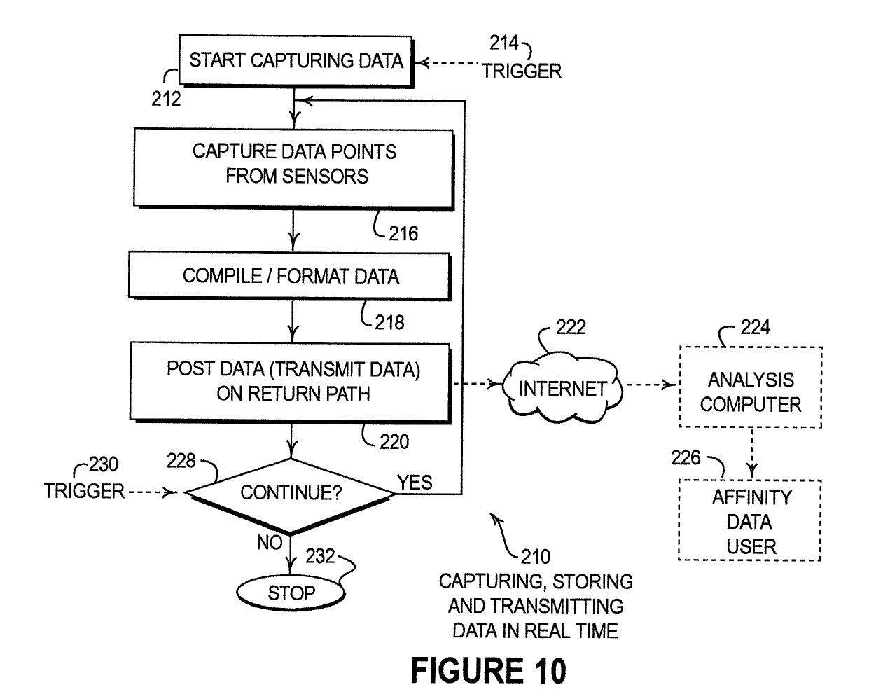

FIG. 10 is a schematic flow diagram of the steps 210 that are used for capturing, storing, and transmitting data in real-time or nearly real-time. As shown in FIG. 10, the set-top box starts capturing data at step 212 which may occur in response to a trigger 214. Again, any of the different ways of providing triggering, including triggers inserted in the vertical blanking interval, periodic triggers generated by the set-top box, and other ways of implementing triggers can be used. At step 216, data is captured from the sensors. At step 218, this data is compiled and formatted. At step 220, the data is posted and transmitted on one of the return paths in accordance with one of the methods indicated herein. For example, the data may be transmitted over the Internet 222 to an analysis computer 224 for use by an affinity data user 226. The process then proceeds to step 228 where a decision is made as to whether the process should continue. A stop trigger 230 may trigger the cessation of the capturing of data. In that case, the process proceeds to step 232 to stop the process. If a trigger 230 has not been received, the process returns to step 216.

The present invention therefore provides a unique system and method for capturing affinity data that can be used for various purposes including selection of video, audio and data feed, generation of affinity data in real-time for modification of content, statistical analysis, and other various purposes.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of selecting and displaying a video segment to a viewer comprising:
transmitting a plurality of video segments from a broadcast center to a viewer;
displaying said video segments to said viewer;
sensing input from said viewer through at least one sensor;
transmitting said input to a remote computer;
analyzing said input to generate affinity data;
selecting a specific video segment based on said affinity data;
transmitting said specific video segment from said broadcast center to said viewer; and
displaying said specific video segment to said viewer.

2. The method of claim 1 wherein said sensor comprises at least one button pressed by a viewer.

3. The method of claim 1 wherein said step of selecting a video segment comprises selecting a video segment during a live broadcast based upon affinity data.

4. A method of collecting affinity data comprising:
transmitting a plurality of video segments from a broadcast center to a viewer;
displaying said video segments to a viewer;
sensing input from said viewer through at least one sensor;
analyzing said input to generate affinity data;
selecting a specific video signal from a plurality of video signals being broadcast to said viewer, said selection being based on said affinity data;
transmitting said affinity data to a remote computer; and
displaying said specific video signal to said viewer.

5. The method of claim 4 wherein said sensor comprises at least one button pressed by a viewer.

6. The method of claim 4 wherein said step of selecting a video segment comprises selecting a video segment during a live broadcast based upon affinity data.
